(19) United States
(12) Patent Application Publication
(10) Pub. No.: US 2018/0267561 A1
(43) Pub. Date: Sep. 20, 2018

(54) AUTONOMOUS CONTROL OF UNMANNED AIRCRAFT

(71) Applicant: Andrew Archer Trench, Warwick, RI (US)

(72) Inventor: Andrew Archer Trench, Warwick, RI (US)

(21) Appl. No.: 15/699,875

(22) Filed: Sep. 8, 2017

Related U.S. Application Data
(60) Provisional application No. 62/393,599, filed on Sep. 12, 2016.

(51) Int. Cl. G05D 1/10; B64C 39/02

(52) U.S. Cl. CPC G05D 1/101; B64C 39/024; B64C 2201/127; B64C 2201/027; B64C 2201/108; B64C 2201/141

(57) ABSTRACT

A method and apparatus for autonomous control of unmanned aircraft. A method includes, in a memory of a flight controller associated with an unmanned aircraft, identifying a target to be captured, the identifying comprising a plurality of target variables, identifying a type of the unmanned aircraft, selecting one or more capture routines, defining desired data parameters, and storing the plurality of target variables, the one or more capture routines and the desired data parameters in the memory as a flight path. A system includes a computing device having at least a processor, a memory and a display, the display including a graphical user interface (GUI), and an unmanned aircraft including at least a flight controller, a power supply, a propeller system, a landing gear system, a Global Positioning System (GPS) device, a camera system and a one or more sensors, the flight controller wirelessly linked to the computing device which provides flight path control information to the flight controller through the GUI.

### CROSS REFERENCE TO RELATED APPLICATIONS

This application claims benefit from U.S. Provisional Patent Application Ser. No. 62/393,599, filed Sep. 12, 2016. This prior application is incorporated by reference in its entirety.

### BACKGROUND OF THE INVENTION

The present invention relates generally to unmanned aircraft, and more specifically to autonomous control of unmanned aircraft.

In general, a drone is an unmanned aerial vehicle (UAV). In the past, UAVs have most often been associated with the military. However, recent technological advances have led to an increasing number of applications for drones in other industries as well as the consumer market. Drones are used in a wide variety of endeavors including search and rescue, surveillance, traffic monitoring, weather monitoring, geographical mapping, agriculture and firefighting.

Besides the simple entertainment factor of remote-controlled vehicles, drones have in the past most often been used for still and video photography—the devices can achieve vantage points that are difficult or impossible to access otherwise. Potential applications for personal drones include, foe example, home security, child monitoring and the creation of virtual tours, among a great number of other possibilities. Programmable drones are expected to create a further market for specialized mobile apps.

Current methods of planning flight paths for an unmanned system do not adequately support the need to fly around vertical structures to gather sensor data. These methods typically rely on a “top down” map view of an area to choose the area to be flown and trigger sensors. This method would suffice for traditional survey of an area flown at a fixed height, but does not allow for complex three dimensional (3D) flight paths to be created easily. Additionally, a two dimensional (2D) top down view does not allow the user to identify locations and heights of nearby obstacles that would need to be avoided during flight.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus for autonomous control of unmanned aircraft.

In one aspect, the invention features a method including, in a memory of a flight controller associated with an unmanned aircraft, identifying a target to be captured, the identifying comprising a plurality of target variables, identifying a type of the unmanned aircraft, selecting one or more capture routines, defining desired data parameters, and storing the plurality of target variables, the one or more capture routines and the desired data parameters in the memory as a flight path.

In another aspect, the invention features a system including a computing device having at least a processor, a memory and a display, the display including a graphical user interface (GUI), and an unmanned aircraft including at least a flight controller, a power supply, a propeller system, a landing gear system, a Global Positioning System (GPS) device, a camera system and a one or more sensors, the flight controller wirelessly linked to the computing device which provides flight path control information to the flight controller through the GUI.

Embodiments of the invention may have one or more of the following advantages.

Methods of the present invention provide a pre-loaded mission planner for vertical structures based on known measurements of towers and illustrate multiple types of paths flown for optimal collection.

Methods of the present invention consider Phot based collection and/or other sensors, along with LIDAR, thermal, gas detection, infrared, Multispectral/Hyperspectral.

Methods of the present invention take into consideration where the horizon is in relation to camera and include multiple angles per mission.

Methods of the present invention consider heights of interest, multiple targets of interest and centering of workflow that can be used to a define center of a structure, a corner pin on a survey-grid mission and define a corner of a building for a building facade mission.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is block diagram of an exemplary unmanned aircraft (“drone”).

FIG. 2 is a flow chart.

FIG. 3 is an exemplary illustration.

FIG. 4 is an exemplary illustration.

FIG. 5 is an exemplary illustration.

FIG. 6 is an exemplary illustration.

FIG. 7 is an exemplary illustration.

FIG. 8 is an exemplary illustration.

FIG. 9 is an exemplary illustration.

FIG. 10 is an exemplary illustration.

FIG. 11 is an exemplary illustration.

FIG. 12 is an exemplary illustration.

FIG. 13 is an exemplary illustration.

FIG. 14 is an exemplary illustration.

FIG. 15 is an exemplary illustration.

FIG. 16 is an exemplary illustration.

FIGS. 17A and 17B are exemplary illustrations.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

The present invention provides a curtain rod bracket and cam lock.

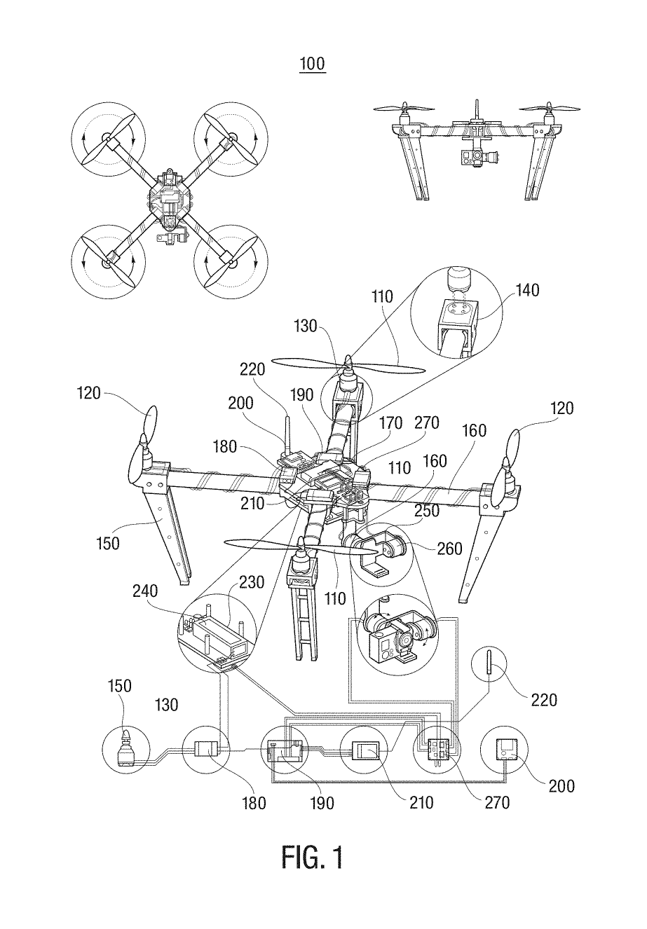

As shown in FIG. 1, an exemplary unmanned aircraft (also referred to herein as a “drone”) 100 includes a standard propeller (“prop”) 110, sometimes referred to as a “tractor” propeller. These props pull the drone 100 through the air like a tractor.

The exemplary drone 100 includes a pusher prop 120 (B). Pusher props are usually found at the back of a drone and push the drone 100. These contra-rotating props exactly cancel out motor torques during stationary level flight. Opposite pitch gives downdraft.

The exemplary drone 100 includes brushless motors 130 (C) and a motor mount 140 (D).

The exemplary drone 100 includes landing gear 150 (E). In some examples, the landing gear 150 (E) is retractable.

The exemplary drone 100 includes a boom 160 (F) that affects maneuverability and stability. A main drone body part 170 (G) is the central hub from which booms 160 (F) radiate like spokes on a wheel. The main drone body part 170 (G) houses, for example, battery, main boards, processors avionics, cameras, sensors and so forth.

The exemplary drone 100 includes electronic speed controllers (ESC) 180 (H). In general, an ESC is an electronic circuit with the purpose to vary an electric motor's speed, its direction and possibly also to act as a dynamic brake. The ESC converts DC battery power into 3-phase AC for driving brushless motors.

The exemplary drone 100 includes a flight controller 190 (I). In general, the flight controller interprets input from a receiver, GPS module, battery monitor, IMU and other onboard sensors. The flight controller regulates motor speeds, via ESCs, to provide steering, as well as triggering cameras or other payloads. The flight controller controls autopilot, waypoints, follow me, failsafe and many other autonomous functions.

The exemplary drone 100 may include a Global Positioning System (GPS) module 200 (J), which often combines a GPS receiver and magnetometer to provide latitude, longitude, elevation, and compass heading from a single device. GPS is an important requirement for waypoint navigation and many other autonomous flight modes.

The exemplary drone 100 includes a receiver 210 (K), often a standard R/C radio receiver unit, and an antenna 220 (L), which may be, for example, a loose wire whip or helical “rubber ducky” type.

The exemplary drone 100 includes a battery 230 (M) and battery monitor 240 (N). The battery monitor 240 (N) provides in-flight power level monitoring to the flight controller 190 (I).

The exemplary drone includes a gimbal 250 (O) that is a pivoting mount that rotates about 1, 2, or 3 axes to provide stabilization and pointing of cameras or other sensors. A gimbal motor 260 (P) is a brushless DC motor that is used for direct-drive angular positioning.

A Gimbal Controller Unit 270 (Q) enables control of direct-drive brushless gimbal motors as if they were standard hobby servos.

The exemplary drone 100 includes one or more cameras and sensors 280 (R).

Software can be used to control the unmanned aircraft 100. In general, the unmanned aircraft control software currently available lacks many features that enable a user to plan complex flight paths required for optimal data collection. The unmanned aircraft 100 is capable of performing an autonomous mission where the unmanned aircraft 100 can move from one location in space to another as well as trigger sensors. This type of autonomous mission is useful in gathering data that can be used for inspection, 3D modeling, mapping, and so forth. Autonomous missions allow for complete and organized data collection much more efficiently than a human operator manually controlling the unmanned aircraft 100 remotely from the ground. These “missions” can be uploaded to the unmanned aircraft 100 before flight or communicated to the unmanned aircraft 100 from a computer on the ground during flight. Technology exists to process multiple photos of a target object or structure and create accurate 3D models, but fails to pair and match photos unless adequate overlap exists between each photo. Planning the frequency and location the sensor data points is critical to accomplish complete data collection of any object. Other sensing such as Light Detection and Ranging (LIDAR) or thermal imaging also benefit from precise movement of the unmanned aircraft 100 around a target. Optimal data collection of a target includes capturing as much of the subject within the sensors field of view and range without gathering data from unwanted surrounding objects or regions. This eliminates wasting storage space, and processing power during and after processing the data. 3D modeling processes benefit from controlled and precise positioning of the sensor and can increase efficiency and accuracy in the data.

Currently available mission planning software does not allow a user to enter specifics about a target such as elevation of a certain feature, or non-symmetrical aspect of a structure, to perform optimal data collection and gather details from these features. In most cases a map provided to a mission planner does not contain all the obstacles as they exist in the real world.

Currently available mission planning software does not include incorporation of camera angle changes during flight as to gather sensor data from the sides of objects.

Currently available mission planning software does not include the ability to create multiple types of mission paths within one mission based on the specified target features (e.g., fly grid in one direction over wide area with camera straight down, then fly a lower grid in both directions over area with detail having the camera at a 45 degree angle).

Many available unmanned aircraft use GPS to navigate and maintain position, but lack the ability to sense nearby obstacles and avoid collision. For an unmanned aircraft to be fully autonomous, identify obstacles, and plan paths in real time requires extensive onboard computing power. This increases the complexity, weight, cost, and power consumption of the aircraft, and can result in unwanted behavior.

To visualize complex flight paths a user needs to see a side profile, or 3D view of the target area.

Battery limitations on unmanned aircraft may require the mission to be split into multiple flights. Currently available software does not allow the user to split the desired data collection mission into multiple missions where the unmanned aircraft returns to the ground to have the battery replaced, then resumes the mission where the unmanned aircraft can resume the mission.

To automatically generate the optimal flight path the process of the present invention considers the onboard sensor's field of view as to capture the exact desired collection of data. On a structure such as a cellular tower there are specific hardware attached that are of particular interest to the user. These objects need to be considered in the process so that appropriate movements of the aircraft, as well as the gimbal or aiming mechanism on the unmanned aircraft, perform during the generated mission.

The present invention is a method that enables a user to identify a desired target of a mission, nearby obstacles to be avoided, and specific points of interest that are considered in planning the flight path that will be flown by the unmanned aircraft autonomously.

The present invention includes a graphical user interface (GUI) which allows an unmanned aircraft operator to identify a target's position, as well as any surrounding assets on the ground, then automatically generate an optimal flight path for the unmanned aircraft to take as well as payload positions and sensor triggering for data collection of that target.

The process of the present invention includes an ability to plan, upload, and view planned missions as well as view realtime data transmitted from the aircraft during flight.

The mission plan created by our process can be flown by an aircraft having no other sensors onboard besides a programmable flight controller with GPS, though additional sensors such as LIDAR altimeter, stereo vision cameras, LIDAR, sonar or any additional sensing hardware can make it more reliable and collect additional data.

In one example of our process a user can identify the area occupied by a cellular communications tower and the height of the tower to inform the process of the position of the tower to generate the flight path and the payload positions required to ensure data is collected of the entire tower and to avoid collision with the tower.

In another example of our process, a user can see the proposed flight path in 3D overlaid on existing 3D dimensional representation of the area to ensure the proper path is being flown and collisions are not present in the flight plan.

In another example of our process the user would identify a large area to be scanned, and also identify objects within that large area that would require additional detail. The process creates a “grid” flight pattern based on the desired overlap of the photos to capture the large area, as well as additional flight paths and camera angles needed to capture data of the specified targets such as tight circle around the object at a lower altitude.

The resulting data from the unmanned aircraft 100 after flying missions from this process makes adequate source data for 3D reconstruction from photos, LIDAR point cloud models, thermal imaging, video inspection, multispectral analysis, photo inspection, and virtual tours as examples. Additional benefits for data resulting from our method of mission planning include:

Better “side wall” data of any tall structure (e.g., windows and siding of a house instead of just the roof)

Better penetration to ground under tree canopy or overhanging objects (e.g., the ground beneath a stand of trees)

Better detail of any complex object (e.g., detail data of a jagged rock protruding from a mountainside)

To obtain complete, detail oriented, and optimal sensed data of any structure using an unmanned aircraft, a specific flight path and specific orientation of the sensor(s) is required. The process fully described herein enables a user to identify a desired target, surrounding obstacles, and specific details within the target to create optimal flight paths for the unmanned aircraft to fly and collect the desired sensor data. The paths that are created by the process can include multiple types of routines. This ensures that the compete area of the desired target is captured by the sensors. In the following examples this description refers to a cellular tower as the target data to be acquired. It should be appreciated that the process described herein may be used for other targets. In the process described herein, the user, using a 3D model or map view of the area view, identifies key elements that informs the process how to plan the mission.

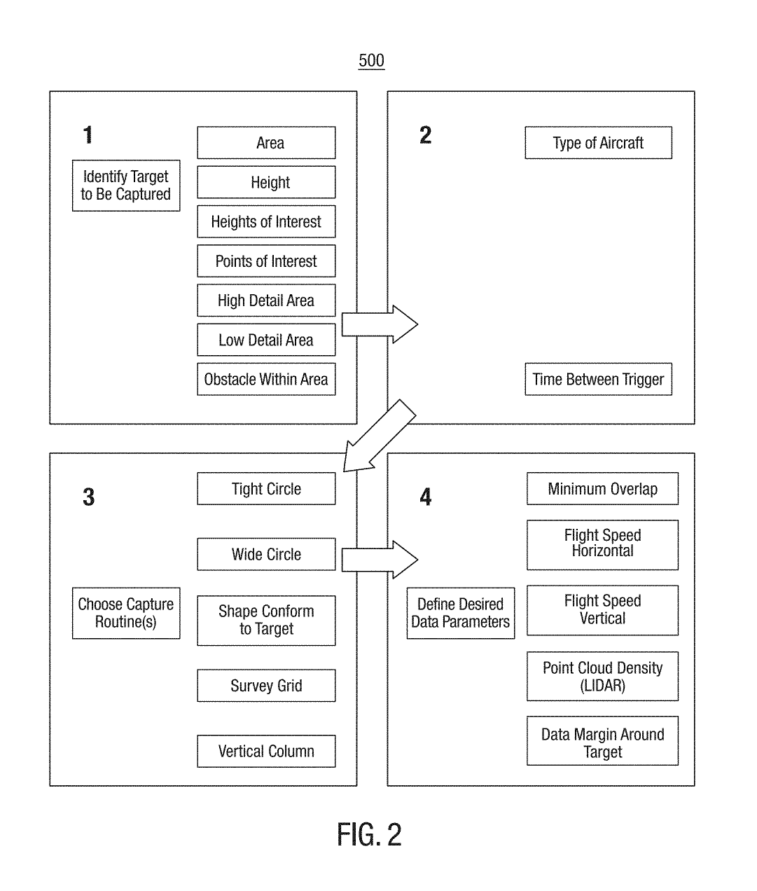

As shown in FIG. 2, a flow chart 500 illustrates the options that may be considered to fly a cellular tower and surrounding land.

The parameters allow the process 500 to generate an optimal flight path to perform a mission that includes one of, a combination of, or all the methods of data collection included in the capabilities of the aircraft. Methods of flight path can include but are not limited to:

Circling the tower from a distance maintaining a full view of the tower within the camera or sensor's filed of view

Circling the tower at close proximity gathering close, detailed, data

Circling the tower at close proximity gathering close, detailed, data with varied angles of payload

Flying vertical columns at close proximity gathering close, detailed, data

Flying vertical columns at close proximity gathering close, detailed, data with varied angles of payload.

Using the cameras FOV, the process 500 calculates the distance needed to maintain data collection of the target tower plus the margin defined by the user. This allows the fewest number of pixels in each image to be wasted while maintaining the entire target in view for optimal modeling of the tower. This is used during the mission method which the aircraft would circle at multiple altitudes from a distance and maintain view of the entire target area.

The user can then execute the mission and view realtime feedback from the aircraft on the progress of the mission within the process 500 as well as transmit updates to the flight plan as needed. The process 500 includes various windows to plan missions, calculate distances, adjust aircraft and sensor configurations, visualize planned missions, and calibrate sensors. The process 500 includes a field of view calculator to build camera profiles that will be used as well as many presets for the most popular cameras and sensors used on unmanned aircraft. The process 500 includes a calculator to quickly determine heights of target objects and obstacles using a simple rangefinder or tape measure to get initial measurements. The process 500 may run completely in a web browser as to be cross-platform capable of running on any computer or mobile device connected to the internet.

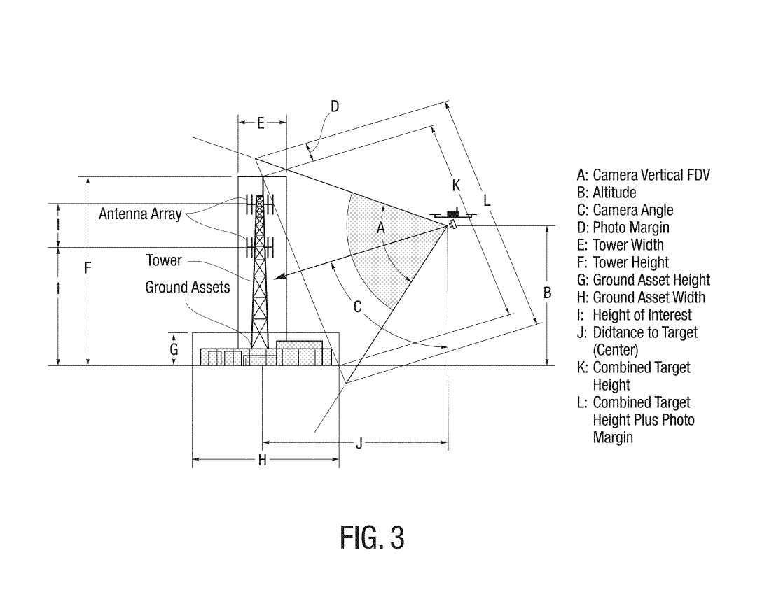

FIG. 3 illustrates parameters that can be entered to create optimal flight path for various automated path generation choices.

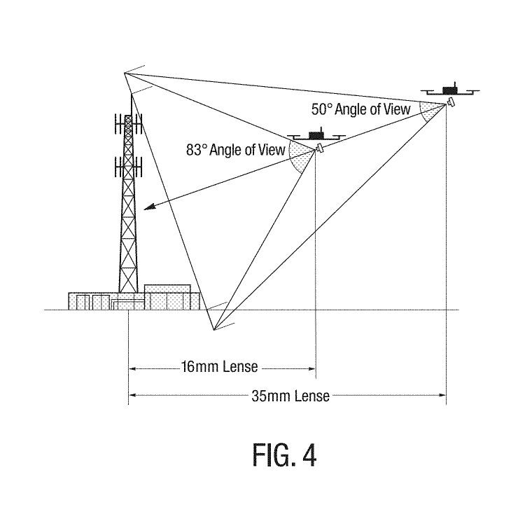

FIG. 4 illustrates the relation of field of view to optimal distance altitude and angle f or the payload to maintain entire target in-frame, with margins considered.

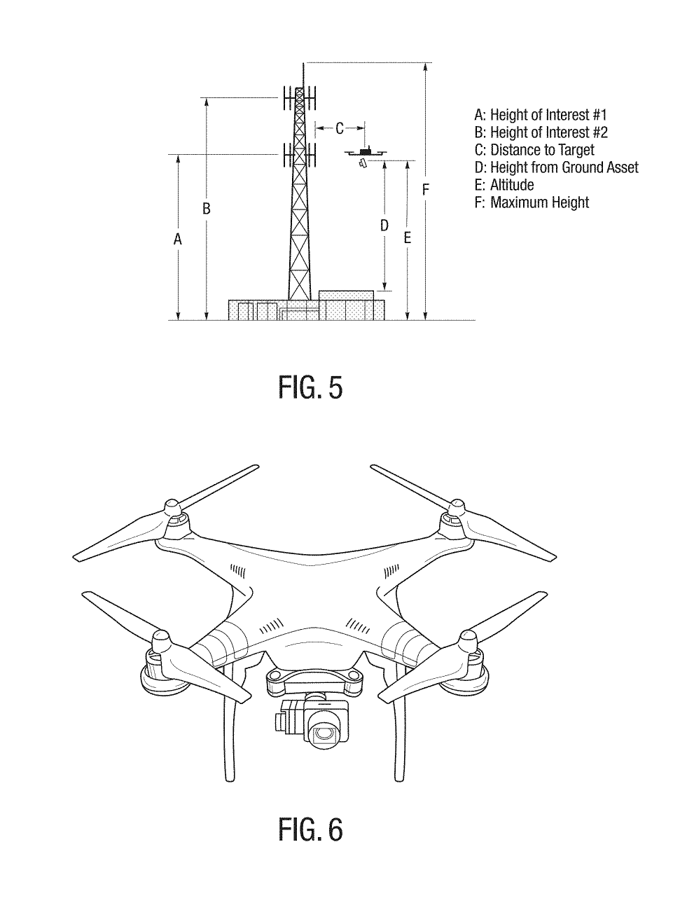

FIG. 5 illustrates parameters that are entered to create optimal flight path for column and tight radius circling of the target path generation.

FIG. 6 illustrates an example of aircraft that can be flown around the tower having no additional sensing onboard to avoid obstacles other than GPS for positioning data.

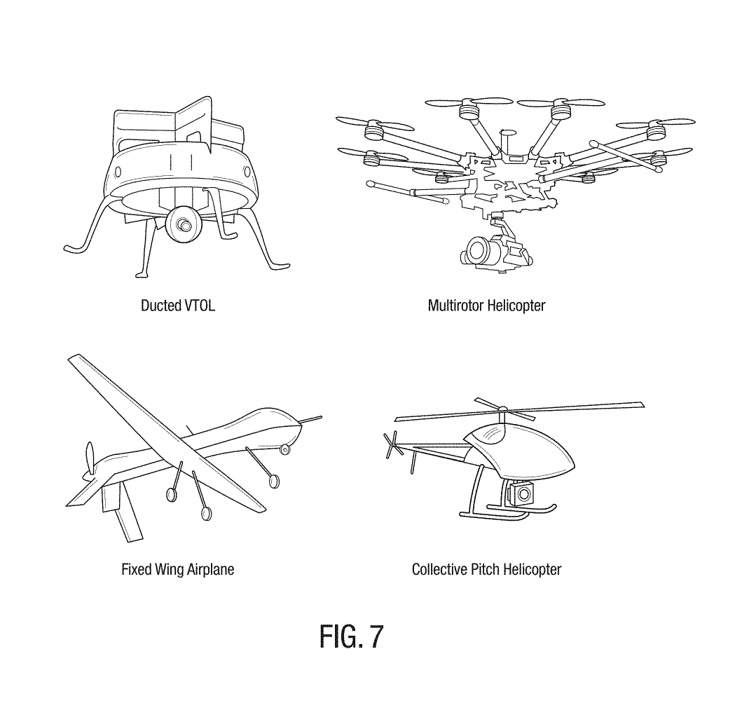

FIG. 7 illustrates examples of other types of unmanned aircraft.

FIG. 8 shows optimal camera positions and angles at various altitudes with a specific camera vertical field of view.

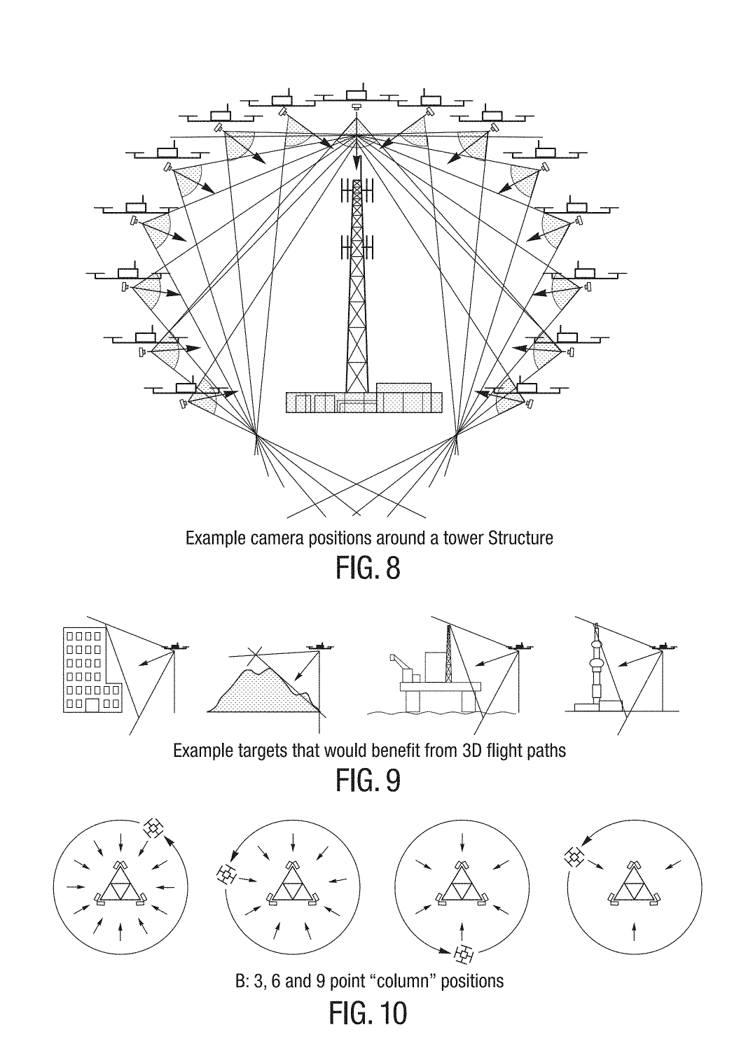

FIG. 9 shows various vertical structures that would benefit from having 3Dimensional flight path creation for optimal data collection by unmanned aircraft.

FIG. 10 shows various configurations that could be chosen for column flight paths to gather more or less data around the structure depending on the overlap and saturation of data desired.

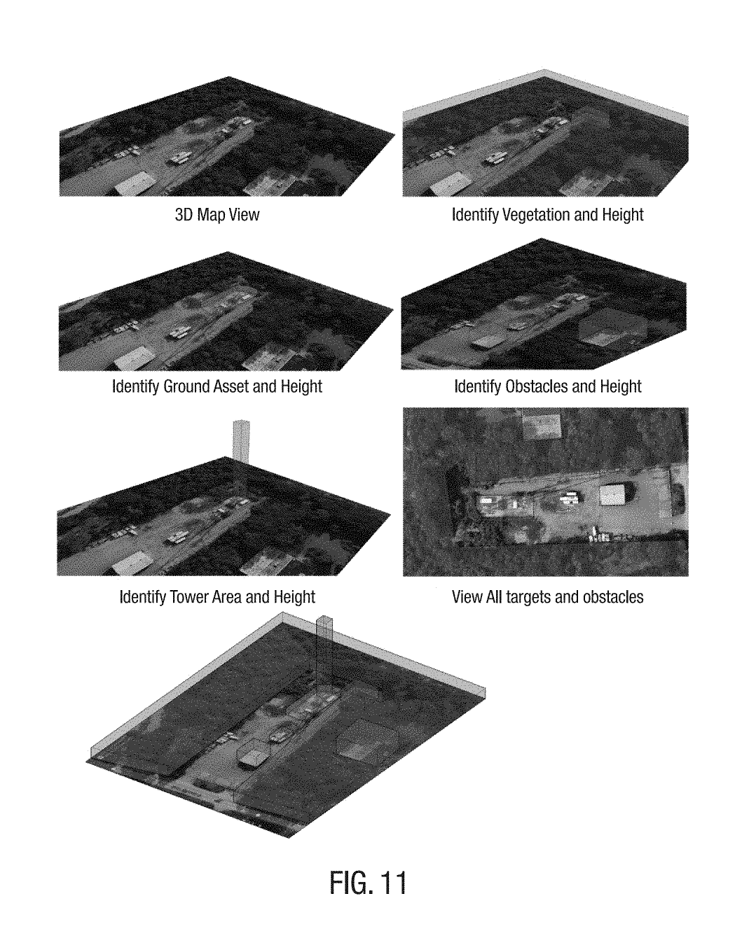

FIG. 11 shows the steps that are taken to identify the target to be flown and the surrounding known obstacles to be avoided during flight path generation.

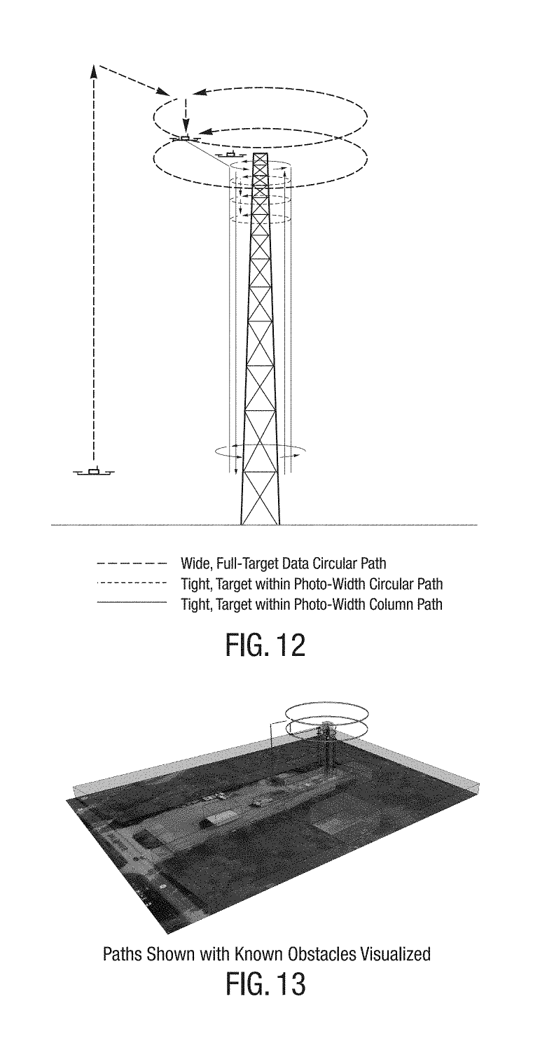

FIG. 12 shows options for flightpath types visualized as they may appear to give the unmanned aircraft operator the ability to identify possible path conflicts with the target.

FIG. 13 shows options for flightpath types visualized as they may appear in the software to give the unmanned aircraft operator the ability to identify possible path conflicts with the target as well as surrounding obstacles such as trees and surrounding buildings.

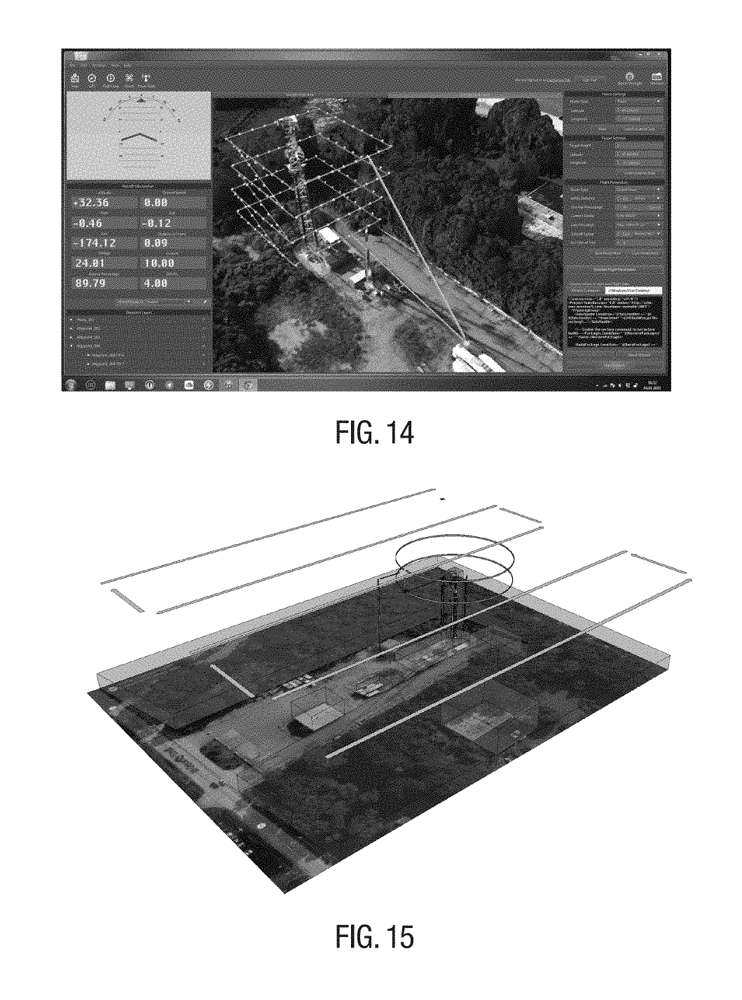

FIG. 14 shows how the graphical user interface may appear, having split view of telemetry from the aircraft, 3D map view of the area to be flown, parameters to generate the flight paths chosen, and the 3D visualization of the flight path overlaid on top of the 3D map of the area.

FIG. 15 shows multiple flight path options that could be included in a single mission including an overall grid pattern, wide circles, tight circles, and vertical column paths. The combination of all the paths would create complete, dense data of the target as well as a complete survey of the surrounding area.

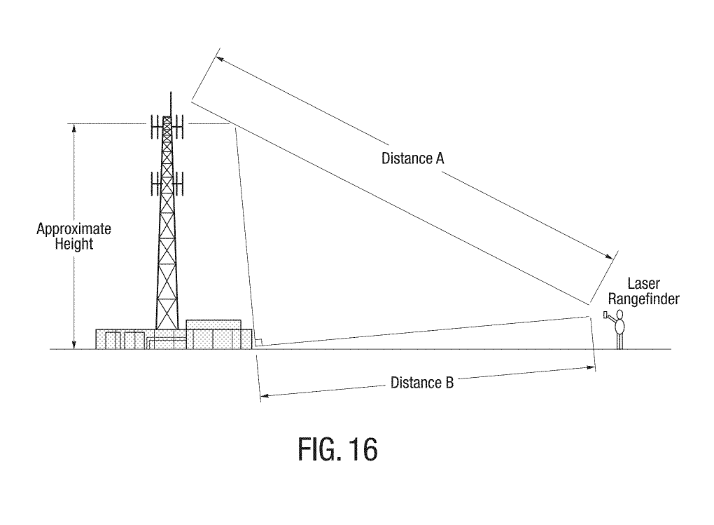

FIG. 16 shows the method a user would use to quickly get approximate heights of target objects and obstacles using a simple rangefinder and the calculator in the mission planner software. The user would take a measurement of the highest point of the target and the lowest point close to the center, then enter these numbers into the calculator. The calculator would then use these two distances to triangulate the approximate height.

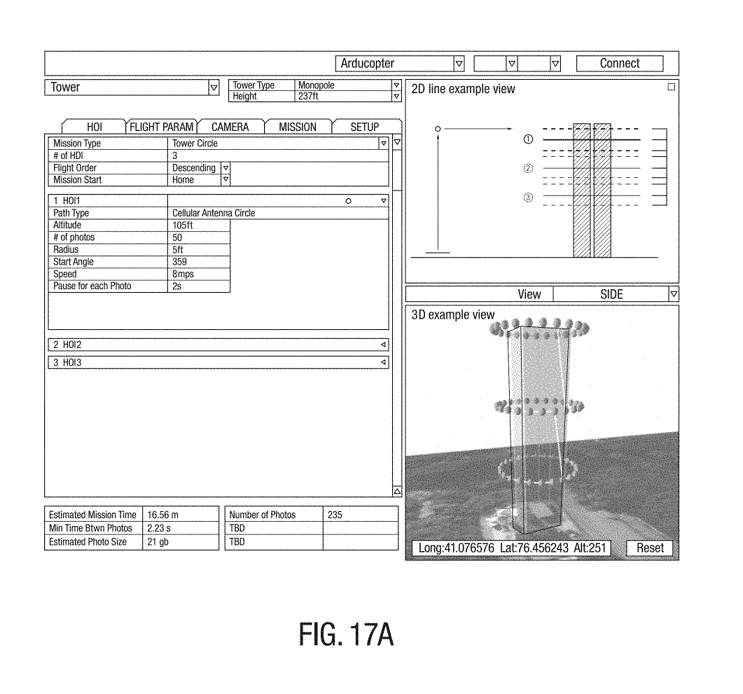

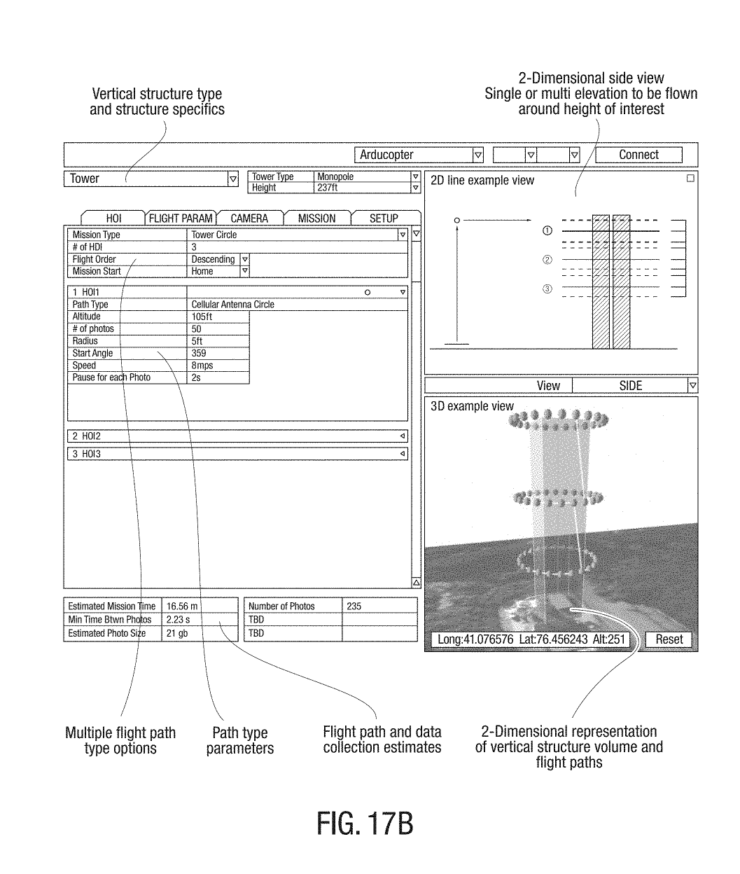

FIGS. 17A and 17B illustrate a selection of a height of interest in an exemplary screenshot. More specifically, the illustrations show a screen having 2D and 3D representation of vertical structure with visualization of flight path to be flown by the drone. In addition, it also shows parameters that may be specified to inform our process of heights and posts of interest on the vertical structure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
in a memory of a flight controller associated with an unmanned aircraft, identifying a target to be captured, the identifying comprising a plurality of target variables;
identifying a type of the unmanned aircraft;
selecting one or more capture routines;
defining desired data parameters; and
storing the plurality of target variables, the one or more capture routines and the desired data parameters in the memory as a flight path.

2. The method of claim 1 wherein the type of the unmanned aircraft is a drone.

3. The method of claim 1 wherein the plurality of target variables include one or more of an area, a height, heights of interest, points of interest, high detail area, low detail area and obstacles within an area.

4. The method of claim 1 wherein the one or more capture routines are selected from the group consisting of a tight circle routine, a wide circle routine, a shape to conform with target routine, a survey grid routine and a vertical column routine.

5. The method of claim 1 wherein the data parameters are selected from the group consisting of a minimum overlap parameter, a flight speed horizontal parameter, a flight speed vertical parameter, a point cloud density parameter and a data margin around target parameter.

6. The method of claim 1 further comprising displaying the flight path in a three dimensional representation overlaid on an existing three dimensional representation of the area to ensure the proper path is being flown and collisions are avoided.

7. A system comprising:
a computing device having at least a processor, a memory and a display, the display comprising a graphical user interface (GUI); and
an unmanned aircraft comprising at least a flight controller, a power supply, a propeller system, a landing gear system, a Global Positioning System (GPS) device, a camera system and a one or more sensors, the flight controller wirelessly linked to the computing device which provides flight path control information to the flight controller through the GUI.

8. The system of claim 7 wherein the flight path control information comprises a type of the unmanned aircraft.

9. The system of claim 8 wherein the flight path control information further comprises a plurality of variables associated with a target.

10. The system of claim 9 where the variables associated with the target include one or more of an area, a height, heights of interest, points of interest, high detail area, low detail area and obstacles within an area.

11. The system of claim 9 wherein the flight path control information further comprises one or more capture routines selected from the group consisting of a tight circle routine, a wide circle routine, a shape to conform with target routine, a survey grid routine and a vertical column routine.

12. The system of claim 11 wherein the flight path control information further comprises data parameters selected from the group consisting of a minimum overlap parameter, a flight speed horizontal parameter, a flight speed vertical parameter, a point cloud density parameter and a data margin around target parameter.
